(19) United States
(12) Patent Application Publication
(10) Pub. No.: US 2026/0111664 A1
(43) Pub. Date: Apr. 23, 2026

(54) SYSTEM FOR ORDER MONITORING AND DISPLAY

(71) Applicant: Aroot Co., Ltd., Osan-si (KR)

(72) Inventors: Hyung Geun SEOK, Uiwang-si (KR); Jin Woo CHOI, Osan-si (KR); Seok Jin JO, Suwon-si (KR)

(73) Assignee: Aroot Co., Ltd., Osan-si (KR)

(21) Appl. No.: 18/983,314

(22) Filed: Dec. 16, 2024

(30) Foreign Application Priority Data
Oct. 18, 2024 (KR) 10-2024-0142545

(51) Int. Cl. G06F 40/205; G06F 16/3332; G06F 16/338

(52) U.S. Cl. CPC G06F 40/205; G06F 16/3334; G06F 16/338

(57) ABSTRACT

A system for order monitoring and display according to an embodiment of the present invention includes: an order terminal generating an order sheet including order information and transmitting data of the order sheet; and a kitchen display system (KDS) receiving the data of the order sheet, searching for a plurality of keywords in the order sheet regardless of a format of the order sheet, and parsing and displaying order information corresponding to the plurality of searched keywords from the order sheet, wherein the kitchen display system (KDS) includes a parsing simulator, the parsing simulator may display the order sheet when at least some of the plurality of keywords are not searched in the order sheet, and parse order information corresponding to an unsearched keyword.

### CROSS-REFERENCE TO RELATED APPLICATION

This application claims the benefit of priority under 35 U.S. C. § 119(a) to Korean Patent Application No. 10-2024-0142545 filed on Oct. 18, 2024, the entire contents of which is incorporated herein by reference.

### BACKGROUND

### (a) Technical Field

The present invention relates to a system for order monitoring and display, which displays order information of a customer in a kitchen.

### (b) Background Art

In order to check order information received from a customer in a kitchen and cook a menu according to the order information, a kitchen display system (KDS) is developed and used in food businesses. The kitchen display system (KDS) is electrically connected to a point-of-sales (POS) terminal, receives and displays order information input to the POS terminal, and allows cookers to monitor the displayed order information to process an order.

In order for the kitchen display system (KDS) to receive the order information input to the POS terminal and display the order information, the kitchen display system (KDS) must be linked to a database connected to the POS terminal, and a procedure in which order information such as menu, order type, or other conditions must be input to the database must be performed in advance. Since such a procedure must be repeatedly performed according to types of POS terminals connected to the kitchen display system (KDS), it may be cumbersome for a user who uses the KDS.

In addition, as mobile and wireless communication technologies develop, the number of order platforms that receive and handle customers'orders are increasing. Its examples include POS terminals that handle orders in stores, terminals linked to delivery applications that can order a menu of food businesses within mobile devices, and terminals linked to Internet online services that can order menus of food businesses within the website, and Kiosk, which orders a menu in the store without a response of an employee, and in order to display order information of various order platforms in the kitchen display system (KDS), there are problems in that a separate program which can be applied to the order platform should be installed, order information having different order formats should be additionally input to the database, update should be performed whenever a new order platform appears, and it is necessary to cope with environments of various order platforms such as requesting additional installation of the database or a server.

### SUMMARY OF THE DISCLOSURE

The present invention may provide a system for order monitoring and display including a kitchen display system (KDS) that may parse and display order information of order sheet having various formats.

A system for order monitoring and display according to an embodiment includes: an order terminal generating an order sheet including order information and transmitting data of the order sheet; and a kitchen display system (KDS) receiving the data of the order sheet, searching for a plurality of keywords in the order sheet regardless of a format of the order sheet, and parsing and displaying order information corresponding to the plurality of searched keywords from the order sheet, wherein the kitchen display system (KDS) includes a parsing simulator, the parsing simulator may display the format of the order sheet when at least some of the plurality of keywords are not searched in the order sheet, and parse order information corresponding to an unsearched keyword.

The order information may include an order number, order type information, and order menu information.

The kitchen display system (KDS) may search for a division line in the order sheet, and recognize and parse order information below the searched division line as the order menu information.

The kitchen display system (KDS) may search for a menu as the keyword in the order sheet, and recognize and parse order information below the searched menu as the order menu information.

The kitchen display system (KDS) may recognize the order menu information in the order sheet, recognize and parse a smallest number in the order menu information as a quantity, and recognize and parse a word displayed at a leftmost portion in the order menu information as a menu name.

The kitchen display system (KDS) may recognize the order menu information in the order sheet, search for a symbol in the order menu information, and recognize and parse a word next to the searched symbol as an option.

The kitchen display system (KDS) according to the present invention includes a keyword list, and can search for a keyword to parse order information within an order sheet corresponding to the keyword. As a result, a cumbersome task such as installing programs that need to be installed to be compatible with various order platforms, additionally inputting order information with different formats according to an order terminal to a database, or performing updates every time a new order terminal is added may not be performed.

The kitchen display system (KDS) according to the present invention is applied to various order platforms or order terminals, and the order information necessary regardless of format, layout, form, font, letter size, and language of the order sheet can be parsed and the parsed order information can be displayed.

### BRIEF DESCRIPTION OF THE DRAWINGS

FIG. 1 is a block diagram illustrating a system for order monitoring and display according to an embodiment of the present invention.

FIG. 2 is an exemplary diagram illustrating an order sheet, and a screen of a display unit of a kitchen display system (KDS) according to an embodiment of the present invention.

FIG. 3 is an exemplary diagram illustrating an order sheet, and a screen of a display unit of a kitchen display system (KDS) according to an embodiment of the present invention.

FIG. 4 is an exemplary diagram illustrating an order sheet, and a screen of a display unit of a kitchen display system (KDS) according to an embodiment of the present invention.

FIG. 5 is an exemplary diagram illustrating an order sheet, and a screen of a display unit of a kitchen display system (KDS) according to an embodiment of the present invention.

FIG. 6 is an exemplary diagram illustrating the screen of the display unit of the kitchen display system (KDS) according to an embodiment of the present invention.

FIG. 7 is an exemplary diagram illustrating the screen of the display unit of the kitchen display system (KDS) according to an embodiment of the present invention.

### DETAILED DESCRIPTION

The objects described above and other objects, advantages and features of the present invention, and methods for achieving the same will be more clearly understood from the embodiments described in detail below with reference to the accompanying drawings.

However, the present invention is not limited to the embodiments disclosed below, and may be embodied in various different forms, and the following embodiments are provided only to easily inform those skilled in the art of the object, configuration, and effect of the invention, and the scope of the present invention is defined by the disclosure of the claims.

Meanwhile, the terminology used in this specification is only for the purpose of describing embodiments and is not intended to limit the present invention. In this specification, the singular form also includes the plural form unless the context specifically indicates otherwise. The terms ‘comprise’ and/or ‘comprising’ used in this specification do not exclude that the mentioned component, step, operation, and/or element include the presence or addition of one or more other constituent elements, steps, operations, and/or elements.

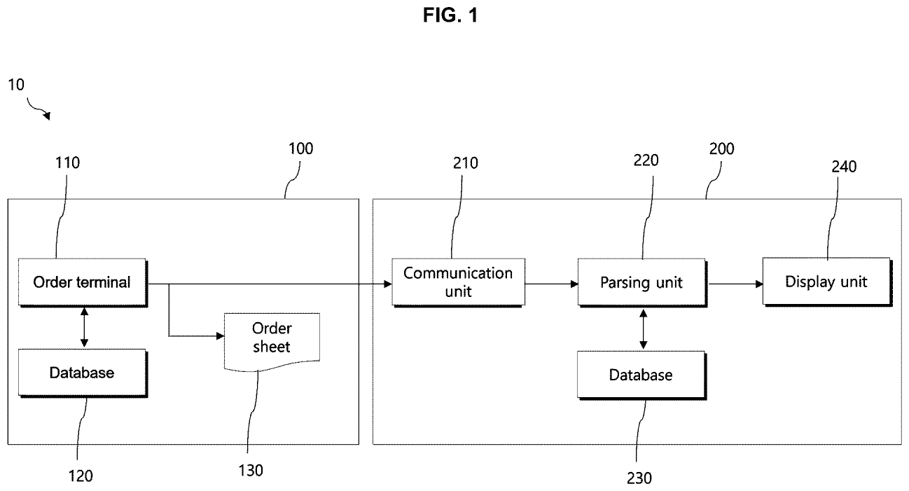

FIG. 1 is a block diagram illustrating a system 10 for order monitoring and display according to an embodiment of the present invention.

Referring to FIG. 1, the system 10 for order monitoring and display may include an order platform 100 and a kitchen display system (KDS) 200.

The order platform 100 may include an order terminal 110, a database 120, and an order sheet 130.

The order terminal 110 may display order type information, order menu information, a table number, and time on a screen, and click-or touch-input the order type information, order menu information, and table number displayed on the screen according to an order of a customer, and generate order information. In an embodiment, the order terminal 110 may include a POS terminal, a terminal linked with delivery applications of mobile devices, a terminal linked with an Internet online service, or a Kiosk. The order type information may include whether the order is a table order, a delivery order, or a packaging order. The order menu information may include a menu ordered by the customer, a price of the menu, a quantity of the menu, an elapsed time for the order, and a time limit for the menu. The table number may mean a number designated according to a table location in a store. The order information may include the order type information, order menu information, and table number, which are input to the order terminal 110, and an order number, an expected cooking time, and an order elapsed time based on a current time, which are displayed in the order terminal 110.

The order terminal 110 may generate the order sheet 130 including the order information. The order sheet 130 may be output through a printer, or converted into data and electrically transmitted to the kitchen display system (KDS) 200.

The database 120 may store order menu information including a menu, a price for the menu, a quantity for the menu, and a time limit for the menu, and the order terminal 110 may be linked with the database 120 and may display the order menu information.

The kitchen display system (KDS) 200 may include a communication unit 210, a parsing unit 220, a database 230, and a display unit 240.

The communication unit 210 may receive data of the order sheet 130 generated in the order terminal 110. The communication unit 210 may include at least one of a processor, a communication chip, and an antenna for enabling wired and/or wireless communication with the order terminal 110. The communication unit 210 may communicate by communication methods such as serial communication, parallel communication, TCP/IP communication, Wi-Fi, etc., and is not limited by communication methods.

The parsing unit 220 may search for predetermined keywords in the order sheet 130 received through the communication unit 210, and parse order information corresponding to the searched keywords in the order sheet 130. The parsing unit 220 may parse required order information regardless of format, form, font, letter size, and language of the order sheet 130. In an embodiment, the parsing unit 220 may search for “table” as the keyword in the order sheet 130, and recognize and parse a number next to the searched “table” as a table number. In an embodiment, the parsing unit 220 may search for “ordernumber” or “order number” as the keyword in the order sheet 130, and recognize and parse a number next to the searched “ordernumber” or “order number” as an order number. In an embodiment, the parsing unit 220 may search for a division line “---” in the order sheet 130, and recognize and parse order information below the division line “---” as the order menu information. In an embodiment, the parsing unit 220 may search for “menu” as the keyword in the order sheet 130, and recognize and parse order information below the searched “menu” as the order menu information. In an embodiment, the parsing unit 220 may recognize the order menu information in the order sheet 130, recognize and parse a smallest number in the order menu information as a quantity, and recognize and parse a word displayed at a leftmost portion in the order menu information as a menu name. In an embodiment, the parsing unit 220 may recognize the order menu information in the order sheet 130, search for a symbol in the order menu information, and recognize and parse a word next to the searched symbol as an option. In an embodiment, the parsing unit 220 may search for “time” or “order time” as the keyword in the order sheet 130, and recognize and parse a difference between a current time and the searched “time” or “order time” as an order elapsed time. In an embodiment, the parsing unit 220 may search for a time display in the order sheet 130, and recognize and parse a difference between the current time and the searched time display as the order elapsed time.

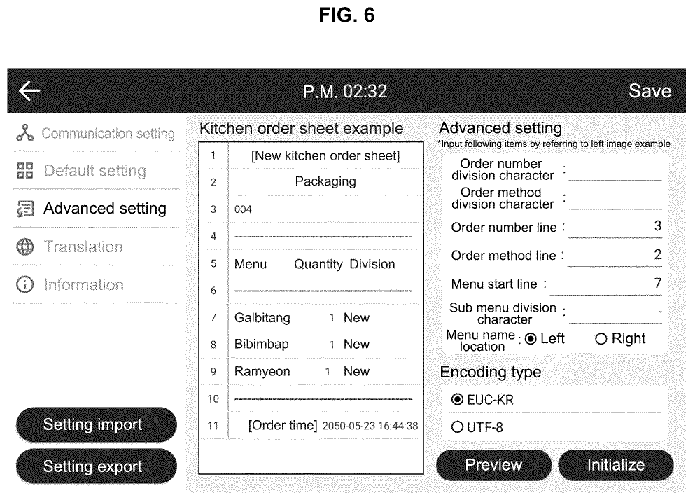

The parsing unit 220 may include a parsing simulator 221 (see FIG. 6). The parsing simulator 221 may display the order 130 when at least some of the keywords are not searched in the order sheet 130, and parse order information corresponding to an unsearched keyword.

The database 230 may store keyword data, and the parsing unit 220 may search for the keywords in the order sheet 130 in link with the database 230.

The display unit 240 may display an image to which the parsed order information is reflected. A cooker in a kitchen may monitor the order information displayed in the display unit 240 and process an order.

As such, the kitchen display system (KDS) 200 may parse the order information of the order sheet 130 regardless of the database 120 in the order platform 100 by using the parsing unit 220, and display the image to which the parsed order information is reflected. Accordingly, the kitchen display system (KDS) 200 may display order information of various order platforms in the kitchen display system (KDS) 200, so it may be generally used.

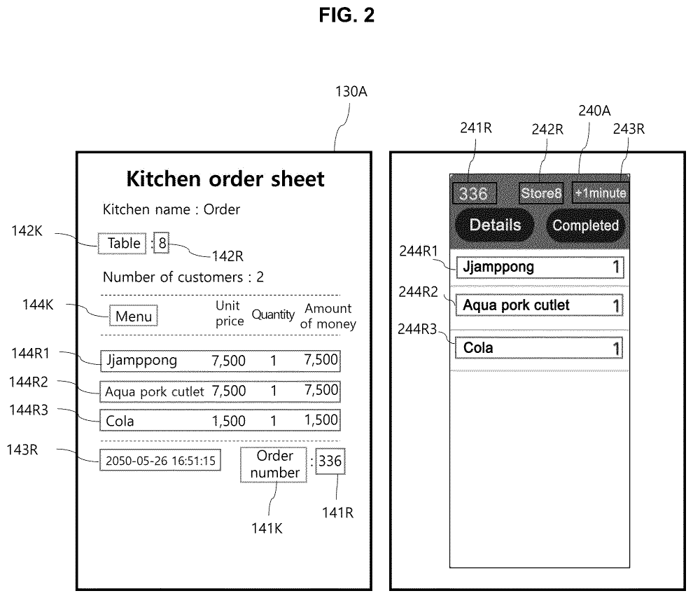

FIG. 2 is an exemplary diagram illustrating a first order sheet 130A, and a screen of a first display unit 240A of a kitchen display system (KDS), according to an embodiment of the present invention.

Referring to FIG. 2, the first order sheet 130A generated in the order terminal 110 of the order platform 100 may be converted into data, and transmitted to the communication unit 210 in the kitchen display system (KDS) 200. In an embodiment, the database 230 in the kitchen display system (KDS) 200 may include “order number”, ‘table”, “order time”, “menu”, and the division line “---”as the keywords.

The parsing unit 220 may search for the “order number” as the keyword in the first order sheet 130A received through the communication unit 210. As a result of searching for the “order number”, the parsing unit 220 may recognize an order number 141K, recognize and parse a number 336 141R next to the order number 141K as the order number, and the first display unit 240A of the kitchen display system (KDS) 200 may display 336 241R.

The parsing unit 220 may search for the “table” as the keyword in the first order sheet 130A received through the communication unit 210. As a result of searching for the “table”, the parsing unit 220 may recognize a table 142K, recognize and parse a number 8 142R next to the table 142K as the table number, and the first display unit 240A of the kitchen display system (KDS) 200 may display the table 8 242R.

The parsing unit 220 may search for the “order time” as the keyword in the first order sheet 130A received through the communication unit 210. As a result of searching for the “order time”, the parsing unit 220 may not recognize the “order time”, and the parsing unit 220 may search for the time display in the first order sheet 130A. As a result of searching for the time display, the parsing unit 220 may recognize and parse a time display 2050-05-26 16:51:15 (143R). The first display unit 240A of the kitchen display system (KDS) 200 may display +1 (243R) which is a difference between the current time and the time display.

The parsing unit 220 may search for the “menu” as the keyword in the first order 130A received through the communication unit 210. As a result of searching for the “menu”, the parsing unit 220 may recognize a menu 144K, and recognize and parse order information below the menu 144K as the order menu information.

The parsing unit 220 may recognize a first order menu information 144R1, recognize 1 which is a smallest number in the first order menu information 144R1 as a quantity, and recognize and perse Jjamppong displayed at a leftmost in the first order menu information 144R1 as a menu name. The first display unit 240A of the kitchen display system (KDS) 200 may display Jjamppong 1 244R1.

The parsing unit 220 may recognize a second order menu information 144R2, recognize 1 which is the smallest number in the second order menu information 144R2 as the quantity, and recognize and parse Aqua pork cutlet displayed at the leftmost portion in the second order menu information 144R2 as the menu name. The first display unit 240A of the kitchen display system (KDS) 200 may display Aqua pork cutlet 1 244R2.

The parsing unit 220 may recognize a third order menu information 144R3, recognize 1 which is the smallest number in the third order menu information 144R3, and recognize and parse cola displayed at the leftmost portion in the third order menu information 144R3 as the menu name. The first display unit 240A of the kitchen display system (KDS) 200 may display cola 1 244R3.

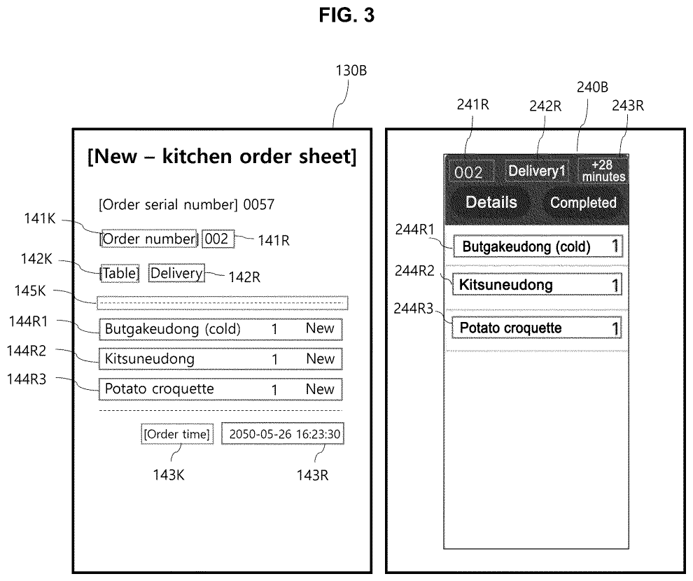

FIG. 3 is an exemplary diagram illustrating a second order 130B, and a screen of a second display unit 240B of the kitchen display system (KDS) 200 according to an embodiment of the present invention.

Referring to FIG. 3, the second order sheet 130B generated in the order terminal 110 of the order platform 100 may be converted into data, and transmitted to the communication unit 210 in the kitchen display system (KDS) 200. The second order sheet 130B may have at least one of format, layout, form, font, letter size, and language different from the first order 130A. In an embodiment, the database 230 in the kitchen display system (KDS) 200 may include “order number”, ‘table”, “order time”, “menu”, and the division line “---” as the keywords.

The parsing unit 220 may search for the “order number” as the keyword in the second order 130B received through the communication unit 210. As a result of searching for the “order number”, the parsing unit 220 may recognize an order number 141K, recognize and parse a number 002 141R next to the order number 141K as the order number, and the second display unit 240B of the kitchen display system (KDS) 200 may display 002 241R.

The parsing unit 220 may search for the “table” as the keyword in the second order sheet 130B received through the communication unit 210. As a result of searching for the “table”, the parsing unit 220 may recognize a table 142K, and recognize and parse delivery 142R which is a word next to the table 142K as order type information, and the second display unit 240B of the kitchen display system (KDS) 200 may display delivery 1 242R.

The parsing unit 220 may search for the “order time” as the keyword in the second order sheet 130B received through the communication unit 210. As a result of searching for the “order time”, the parsing unit 220 may recognize an order time 143K, and recognize and parse a time display 2050-05-26 16:23:30 (143R) next to the order time 143K. The second display unit 240B of the kitchen display system (KDS) 200 may display +28 (243R) which is a difference between the current time and the time display.

The parsing unit 220 may search for the “menu” as the keyword in the second order 130B received through the communication unit 210. As a result of searching for the “menu”, the parsing unit 220 may not recognize the “menu”, and the parsing unit 220 may search for a division line “---” in the second order sheet 130B. As a result of searching for the division line “---”, the parsing unit 220 may recognize a division line 145K, and recognize and parse the following order information below the division line 145K as the order menu information.

The parsing unit 220 may recognize a first order menu information 144R1, recognize 1 which is the smallest number in the first order menu information 144R1, and recognize and parse Butgakeudong (cold) displayed at the leftmost portion in the first order menu information 144R1 as the menu name. The second display unit 240B of the kitchen display system (KDS) 200 may display Butgakeudong (cold) 1 244R1.

The parsing unit 220 may recognize a second order menu information 144R2, recognize 1 which is the smallest number in the second order menu information 144R2 as the quantity, and recognize and parse Kitsuneudong displayed at the leftmost portion in the second order menu information 144R2 as the menu name. The second display unit 240B of the kitchen display system (KDS) 200 may display Kitsuneudong 1 244R2.

The parsing unit 220 may recognize a third order menu information 144R3, recognize 1 which is the smallest number in the third order menu information 144R3, and recognize and parse potato croquettes displayed at the leftmost portion in the third order menu information 144R3 as the menu name. The second display unit 240B of the kitchen display system (KDS) 200 may display potato croquettes 1 244R3.

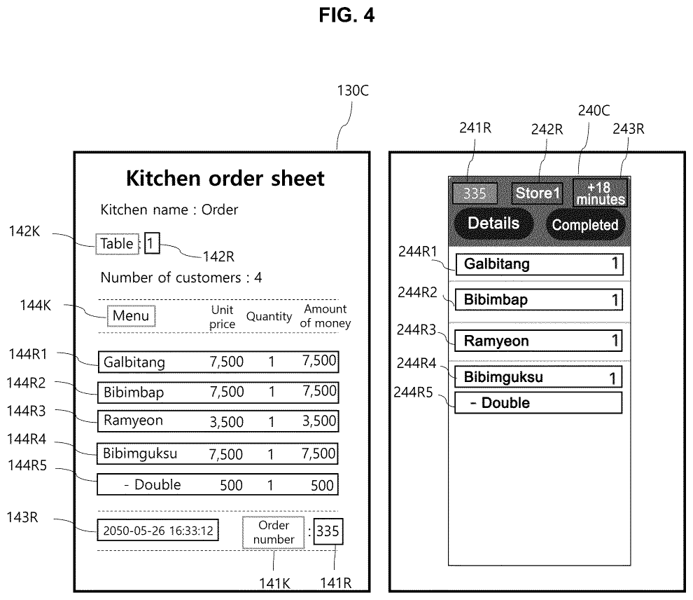

FIG. 4 is an exemplary diagram illustrating a third order sheet 130C, and a screen of a third display unit 240C of the kitchen display system (KDS) according to an embodiment of the present invention.

Referring to FIG. 4, the third order sheet 130C generated in the order terminal 110 of the order platform 100 may be converted into data, and transmitted to the communication unit 210 in the kitchen display system (KDS) 200. The third order sheet 130C may have at least one of format, layout, form, font, letter size, and language different from the first order sheet 130A and the second order sheet 130B. In an embodiment, the database 230 in the kitchen display system (KDS) 200 may include “order number”, ‘table”, “order time”, “menu”, and the division line “---” as the keywords.

The parsing unit 220 may search for the “order number” as the keyword in the third order sheet 130C received through the communication unit 210. As a result of searching for the “order number”, the parsing unit 220 may recognize an order number 141K, recognize and parse a number 335 141R next to the order number 141K as the order number, and the third display unit 240C of the kitchen display system (KDS) 200 may display 335 241R.

The parsing unit 220 may search for the “table” as the keyword in the third order sheet 130C received through the communication unit 210. As a result of searching for the “table”, the parsing unit 220 may recognize a table 142K, recognize and parse a number 1 142R next to the table 142K as the table number, and the third display unit 240C of the kitchen display system (KDS) 200 may display the table 1 242R.

The parsing unit 220 may search for the “order time” as the keyword in the third order 130C received through the communication unit 210. As a result of searching for the “order time”, the parsing unit 220 may not recognize the “order time”, and the parsing unit 220 may search for the time display in the third order sheet 130C. As a result of searching for the time display, the parsing unit 220 may recognize and parse a time display 2050-05-26 16:33:12 (143R). The third display unit 240C of the kitchen display system (KDS) 200 may display +18 (243R) which is a difference between the current time and the time display.

The parsing unit 220 may search for the “menu” as the keyword in the third order sheet 130C received through the communication unit 210. As a result of searching for the “menu”, the parsing unit 220 may recognize a menu 144K, and recognize and parse order information below the menu 144K as the order menu information.

The parsing unit 220 may recognize a first order menu information 144R1, recognize 1 which is the smallest number in the first order menu information 144R1, and recognize and parse Galbitang displayed at the leftmost portion as a menu name in the first order menu information 144R1. The third display unit 240C of the kitchen display system (KDS) 200 may display Galbitang 1 244R1.

The parsing unit 220 may recognize a second order menu information 144R2, recognize 1 which is the smallest number in the second order menu information 144R2 as the quantity, and recognize and parse Bibimbap displayed at the leftmost portion in the second order menu information 144R2 as the menu name. The third display unit 240C of the kitchen display system (KDS) 200 may display Bibimbap 1 244R2.

The parsing unit 220 may recognize a third order menu information 144R3, recognize 1 which is the smallest number in the third order menu information 144R3, and recognize and parse Ramyeon displayed at the leftmost portion in the third order menu information 144R3 as the menu name. The third display unit 240C of the kitchen display system (KDS) 200 may display Ramyeon 1 244R3.

The parsing unit 220 may recognize a fourth order menu information 144R4, recognize 1 which is the smallest number in the fourth order menu information 144R4 as the quantity, and recognize and parse Bibimguksu displayed at the leftmost portion in the fourth order menu information 144R4 as the menu name. The third display unit 240C of the kitchen display system (KDS) 200 may display Bibimguksu 1 244R4.

The parsing unit 220 may recognize a fifth order menu information 144R5, search for a symbol “-” in the fifth order menu information 144R4, and recognize and parse a word next to the searched symbol “-” as the option. The third display unit 240C of the kitchen display system (KDS) 200 may display-double 244R5.

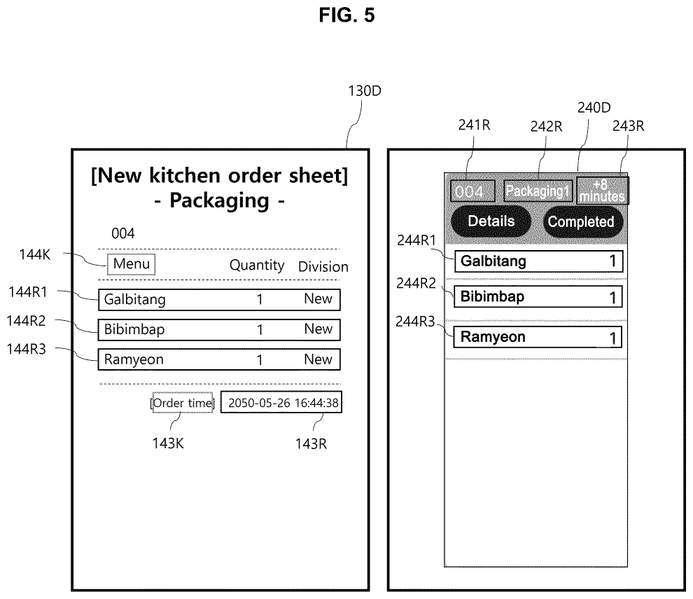

FIG. 5 is an exemplary diagram illustrating a fourth order sheet 130D, and a screen of a fourth display unit 240D of the kitchen display system (KDS) 200 according to an embodiment of the present invention.

Referring to FIG. 5, the fourth order sheet 130D generated in the order terminal 110 of the order platform 100 may be converted into data, and transmitted to the communication unit 210 in the kitchen display system (KDS) 200. The fourth order sheet 130D may have at least one of format, layout, form, font, letter size, and language different from the first order sheet 130A, the second order sheet 130B, and the third order sheet 130C. In an embodiment, the database 230 in the kitchen display system (KDS) 200 may include “order number”, ‘table”, “order time”, “menu”, and the division line “---”as the keywords.

The parsing unit 220 may search for the “order number” and the “table” as the keyword in the fourth order sheet 130D received through the communication unit 210. As a result of searching for the “order number” and the “table”, the parsing unit 220 does not recognize the “order number” and the “table”, so the order number may be parsed by using a parsing simulator 221. The parsing simulator 221 is illustrated in FIG. 6.

Referring to FIG. 6, since the “order number” and the “table” are not searched in the fourth order sheet 130D, the parsing simulator 221 may display the fourth order sheet 130D, sequentially mark line numbers (in the corresponding embodiment, line numbers 1 to 11) at one side of the fourth order sheet 130D from the top according to the number of lines of the fourth order sheet 130D, and parse order information corresponding to the “order number” and the “table” not searched. The user may input line number 3 of the fourth order sheet 130D corresponding to the order number to “order number line”, and input line number 2 of the fourth order sheet 130D corresponding to the “table” (order type information) to an item “order method line”. Further, the user may input values for an item “menu start line”, an item “menu start direction”, and an item “sub menu division character”.

Thereafter, in an order sheet generated in the same type as the fourth order sheet 130D in which the order information is parsed by the paring simulator 221, a number corresponding to line number 3 may be automatically recognized as order information corresponding to the keyword “order number”, and in the order sheet generated in the same type as the fourth order sheet 130D in which the order information is parsed by the paring simulator 221, a word corresponding to line number 2 may be automatically recognized as order information corresponding to the “table” (order type information).

After applying the parsing simulator 221, the fourth display unit 240D of the kitchen display system (KDS) 200 may display 004 241R and packaging 1 242R.

Referring back to FIG. 5, the parsing unit 220 may search for the “order time” as the keyword in the fourth order sheet 130D received through the communication unit 210. As a result of searching for the “order time”, the parsing unit 220 may recognize an order time 143K, and recognize and parse a time display 2050-05-26 16:44:38 (143R) next to the order time 143K. The fourth display unit 240D of the kitchen display system (KDS) 200 may display +8 (243R) which is a difference between the current time and the time display.

The parsing unit 220 may search for the “menu” as the keyword in the fourth order sheet 130D received through the communication unit 210. As a result of searching for the “menu”, the parsing unit 220 may recognize a menu 144K, and recognize and parse order information below the menu 144K as the order menu information.

The parsing unit 220 may recognize a first order menu information 144R1, recognize 1 which is the smallest number in the first order menu information 144R1, and recognize and parse Galbitang displayed at the leftmost portion as a menu name in the first order menu information 144R1. The fourth display unit 240D of the kitchen display system (KDS) 200 may display Galbitang 1 244R1.

The parsing unit 220 may recognize a second order menu information 144R2, recognize 1 which is the smallest number in the second order menu information 144R2 as the quantity, and recognize and parse Bibimbap displayed at the leftmost portion in the second order menu information 144R2 as the menu name. The fourth display unit 240D of the kitchen display system (KDS) 200 may display Bibimbap 1 244R2.

The parsing unit 220 may recognize a third order menu information 144R3, recognize 1 which is the smallest number in the third order menu information 144R3, and recognize and parse Ramyeon displayed at the leftmost portion in the third order menu information 144R3 as the menu name. The fourth display unit 240D of the kitchen display system (KDS) 200 may display Ramyeon 1 244R3.

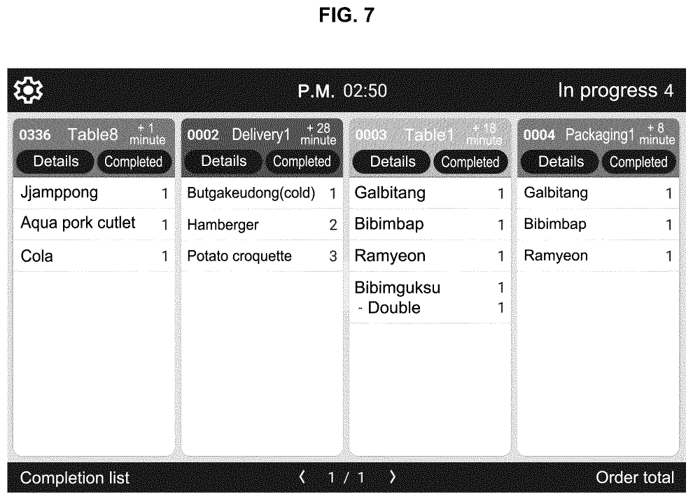

FIG. 7 is an exemplary diagram illustrating the screen of the display unit 240 of the kitchen display system (KDS) 200 according to an embodiment of the present invention.

Referring to FIG. 7, the kitchen display system (KDS) 200 may be applied to various order platforms, and may parse required order information regardless of format, layout, form, font, letter size, and language of the order sheet 130. As a result, the display unit 240 of the kitchen display system (KDS) 200 may include a first display unit 240A, a second display unit 240B, a third display unit 240C, and a fourth display unit 240D displaying the parsed order information. The display unit 240 displays only order information required for cooking in the kitchen to prevent the cooker using the kitchen display system (KDS) 200 from making a mistake in ordering, and the cooker in the kitchen may monitor the order information displayed in the display unit 240, and process the order by using the kitchen display system (KDS) 200.

Although the preferred embodiments of the present invention is described above, the present invention is not limited thereto, and can be implemented with various modifications within the scopes of the claims, and the detailed description of the present invention and the accompanying drawings, and such modifications also belong to the scope of the present invention, of course.

What is claimed is:

1. A system for order monitoring and display, the system comprising:
an order terminal generating an order sheet including order information, and transmitting data of the order sheet; and
a kitchen display system (KDS) receiving the data of the order sheet, searching for a plurality of keywords in the order sheet regardless of a format of the order sheet, and parsing and displaying the order information corresponding to the plurality of searched keywords from the order sheet,
wherein the kitchen display system (KDS) includes a parsing simulator,
the parsing simulator may display the order sheet when at least some of the plurality of keywords are not searched in the order sheet, and parse order information corresponding to an unsearched keyword.

2. The system of claim 1, wherein the order information includes an order number, order type information, and order menu information.

3. The system of claim 2, wherein the kitchen display system (KDS) searches for a division line in the order sheet, and recognizes and parses order information below the searched division line as the order menu information.

4. The system of claim 2, wherein the kitchen display system (KDS) searches for a menu as the keyword in the order sheet, and recognizes and parses order information below the searched menu as the order menu information.

5. The system of claim 2, wherein the kitchen display system (KDS) recognizes the order menu information in the order sheet, recognizes and parses a smallest number in the order menu information as a quantity, and recognizes and parses a word displayed at a leftmost portion in the order menu information as a menu name.

6. The system of claim 2, wherein the kitchen display system (KDS) recognizes the order menu information in the order sheet, searches for a symbol in the order menu information, and recognizes and parses a word next to the searched symbol as an option.
